(19) United States
(12) Patent Application Publication
(10) Pub. No.: US 2018/0275640 A1
(43) Pub. Date: Sep. 27, 2018

(54) PASSIVE COMPLIANCE MECHANISM

(71) Applicant: DELTA ELECTRONICS, INC., Taoyuan City (TW)

(72) Inventors: Michael Schweigler, Taoyuan City (TW); Chih-Cheng Peng, Taoyuan City (TW); Chao-An Pao, Taoyuan City (TW); Tzu-Min Yi, Taoyuan City (TW); Wei-Ying Chu, Taoyuan City (TW)

(21) Appl. No.: 15/695,301

(22) Filed: Sep. 5, 2017

(30) Foreign Application Priority Data
Mar. 23, 2017 (TW) 106109706

(51) Int. Cl. G05B 19/418

(52) U.S. Cl. CPC G05B 19/41875; G05B 19/41865

(57) ABSTRACT

A passive compliance mechanism includes a fixing member, a base and a stiffness adjustment assembly. The base is installed on the fixing member, and includes two notches and an elastic slice. A first end of the elastic slice is connected with the base. A second end of the elastic slice is located near the outer periphery of the fixing member. The stiffness adjustment assembly includes a linear guide, a sliding block and two stopping blocks. The linear guide is installed on the fixing member. The sliding block is movably installed on the linear guide. The two stopping blocks are disposed on the sliding block and synchronously moved with the sliding block. The two stopping blocks are contacted with two opposite sides of the elastic slice to clamp the elastic slice. A stiffness of the base is adjustable according to a clamped position of the elastic slice.

### FIELD OF THE INVENTION

The present invention relates to a passive compliance mechanism, and more particularly to a passive compliance mechanism capable of adjusting the magnitude of the stiffness.

### BACKGROUND OF THE INVENTION

With increasing development of science and technology, robots have been widely used in various fields in order to enhance the production speed and reduce the labor cost. In some situations, the robot is equipped with a compliance mechanism. The use of the compliance mechanism can comply with the flexible operation for the assembly process and enhance the safety of the robot that is in direct contact with the user (e.g., the service robot). Due to the compliance mechanism, the robot has the compliant property. Generally, the compliance mechanisms are divided into two types, i.e., an active compliance mechanism and a passive compliance mechanism. By absorbing energy or generating a compliant action, the passive compliance mechanism achieves the compliance. Since the response rate is very fast, the passive compliance mechanism is widely applied to various kinds of robots.

Conventionally, the passive compliance mechanism uses the elastic force of a spring to achieve the compliance efficacy. Since the elasticity coefficient of the spring used in the conventional passive compliance mechanism is fixed, the stiffness of the conventional passive compliance mechanism is fixed and unable to be adjusted. If the conventional passive compliance mechanism is applied to a different working environment or a different robot, it is necessary to adjust the stiffness. In accordance with the conventional approach of adjusting the stiffness, the spring is replaced with a new one or the design of the passive compliance mechanism is changed. In other words, the applications of the conventional passive compliance mechanism are insufficient and the fabricating cost is high.

Therefore, there is a need of providing an improved passive compliance mechanism in order to overcome the above drawbacks.

### SUMMARY OF THE INVENTION

An object of the present invention provides a passive compliance mechanism capable of adjusting the magnitude of the stiffness in order to overcome the drawbacks of the conventional technologies.

In accordance with an aspect of the present invention, there is provided a passive compliance mechanism. The passive compliance mechanism includes a fixing member, a base and a stiffness adjustment assembly. The base is installed on the fixing member, and includes two notches and an elastic slice. The two notches are arranged side by side. The elastic slice is arranged between the two notches and protruded externally from the base in a direction toward an outer periphery of the fixing member. A first end of the elastic slice is connected with the base. A second end of the elastic slice is located near the outer periphery of the fixing member. The stiffness adjustment assembly is installed on the fixing member, and includes a linear guide, a sliding block and two stopping blocks. The linear guide is installed on the fixing member and aligned with the elastic slice. The sliding block is movably installed on the linear guide. The two stopping blocks are fixedly disposed on the sliding block and synchronously moved with the sliding block. The two stopping blocks are contacted with two opposite sides of the elastic slice to clamp the elastic slice. A stiffness of the base is adjustable according to a clamped position of the elastic slice.

In accordance with another aspect of the present invention, there is provided a passive compliance mechanism. The passive compliance mechanism includes a fixing member, a base, a first stiffness adjustment assembly and a second stiffness adjustment assembly. The base is installed on the fixing member, and includes a first notch, a second notch and an elastic slice. The elastic slice is installed on the base, accommodated within the first notch, and protruded externally from the base in a direction toward an outer periphery of the fixing member. A first end of the elastic slice is connected with the base. A second end of the elastic slice is located near the outer periphery of the fixing member. The first stiffness adjustment assembly is installed on the fixing member, and includes a first linear guide, a first sliding block and two first stopping blocks. The first linear guide is installed on the fixing member and aligned with the elastic slice. The first sliding block is movably installed on the first linear guide. The two first stopping blocks are fixedly disposed on the first sliding block and synchronously moved with the first sliding block. The two first stopping blocks are contacted with two opposite sides of the elastic slice to clamp the elastic slice. A stiffness of the base is adjustable according to a clamped position of the elastic slice. The stiffness switching module is installed on the fixing member, and includes a second linear guide, a second sliding block and a second stopping block. The second linear guide is installed on the fixing member. The second sliding block is movably installed on the first linear guide and selectively moved to a first position or a second position. The second stopping block is fixedly disposed on the second sliding block and synchronously moved with the second sliding block. When the second sliding block is moved to the first position, the second stopping block is moved to the second notch and engaged with the second notch, so that the base has the maximum stiffness. When the second sliding block is moved to the second position, the second stopping block is disengaged from the second notch.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a passive compliance mechanism according to a first embodiment of the present invention;

FIG. 2 is a schematic perspective view illustrating a variant example of the passive compliance mechanism of FIG. 1;

FIG. 3 is a schematic perspective view illustrating a passive compliance mechanism according to a second embodiment of the present invention;

FIG. 4 is a schematic top view illustrating the passive compliance mechanism of FIG. 3;

FIG. 5 is a schematic perspective view illustrating a variant example of the passive compliance mechanism of FIG. 3; and

FIG. 6 is a schematic top view illustrating another variant example of the passive compliance mechanism of FIG. 3.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

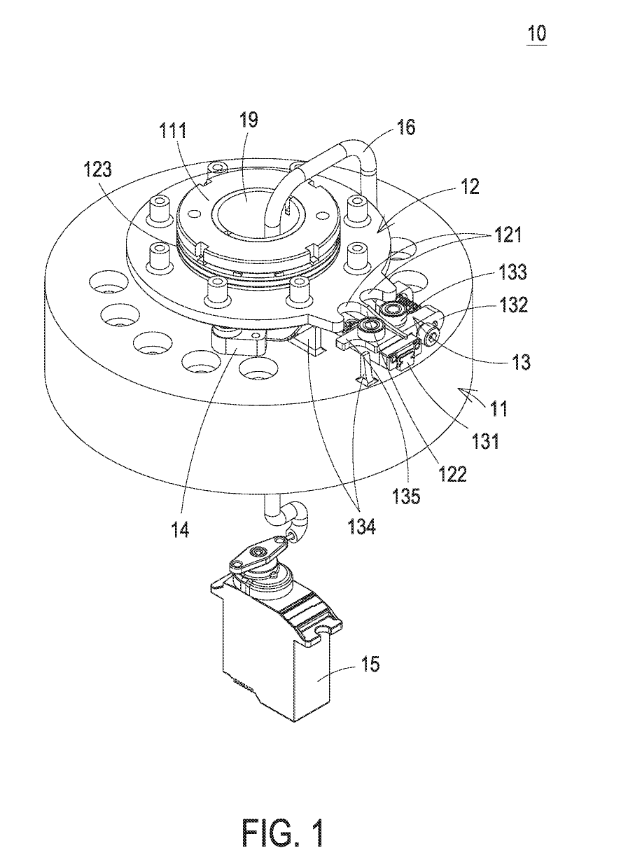

FIG. 1 is a schematic perspective view illustrating a passive compliance mechanism according to a first embodiment of the present invention. As shown in FIG. 1, the passive compliance mechanism 10 is applied to a service robot, a collaborative robot, an industrial robot or any other appropriate robot. The passive compliance mechanism 10 is installed in a joint of an arm or a leg of the robot. In an embodiment, the passive compliance mechanism 10 comprises a fixing member 11, a base 12 and a stiffness adjustment assembly 13.

The fixing member 11 is assembled with the joint of the robot. The base 12 is installed on the fixing member 11 through a bearing (not shown). The base 12 is made of a flexible (or elastic) material. When an external force is applied to the base 12, the base 12 is subjected to an elastic deformation according to the magnitude of the stiffness of the base 12. Consequently, the base 12 is moved relative to the fixing member 11. Under this circumstance, the base 12 provides the compliant function. In this embodiment, the base 12 comprises two notches 121 and an elastic slice 122. The two notches 121 are arranged side by side. Moreover, the two notches 121 are concavely formed in the direction from an outer periphery of the base 12 to the center of the base 12. The elastic slice 122 is arranged between the two notches 121. Moreover, the elastic slice 122 is protruded externally from the base 12 in the direction toward the outer periphery of the fixing member 11. A first end of the elastic slice 122 is connected with the base 12. A second end of the elastic slice 122 is located near the outer periphery of the fixing member 11. Preferably, the elastic slice 122 is integrally formed with the base 12.

The stiffness adjustment assembly 13 is installed on the fixing member 11. In an embodiment, the stiffness adjustment assembly 13 comprises a linear guide 131, a sliding block 132 and two stopping blocks 133. The linear guide 131 is installed on the fixing member 11. Moreover, the linear guide 131 is aligned with the elastic slice 122. The sliding block 132 is movably installed on the linear guide 131. The two stopping blocks 133 are fixedly disposed on the sliding block 132 and synchronously moved with the sliding block 132. Moreover, the two stopping blocks 133 are contacted with two opposite sides of the elastic slice 122. Consequently, the elastic slice 122 is clamped by the two stopping blocks 133. The stiffness of the base 12 is adjustable according to the position of the elastic slice 122 clamped by the two stopping blocks 133. The two notches 121, the elastic slice 122 and the stiffness adjustment assembly 13 are collaboratively defined as a first stiffness adjustment module. The first stiffness adjustment module can be used to adjust the magnitude of the stiffness of the base 12.

Preferably but not exclusively, the sizes and shapes of the two notches 121 match the sizes and shapes of the two stopping blocks 133. The two notches 121 are concavely formed in the direction from the outer periphery of the base 12 to the center of the base 12. Consequently, the two stopping blocks 133 can be engaged with the two notches 121. As mentioned above, the two stopping blocks 133 are moved with the sliding block 132. When the two stopping blocks 133 are moved to the two notches 121 and engaged with the two notches 121, the base 12 has the maximum stiffness. Meanwhile, even if an external force is applied to the base 12, the base 12 is not subjected to the elastic deformation because the two stopping blocks 133 are engaged with the two notches 121. Consequently, the base 12 is indirectly fixed on the fixing member 11. Since the base 12 is not subjected to the elastic deformation relative to the fixing member 11, the stiffness of the base 12 is similar to the stiffness of the fixing member 11. When the two stopping blocks 133 are detached from the two notches 121 and disengaged from the two notches 121, the two stopping blocks 133 are moved between the first end and the second end of the elastic slice 122. Consequently, the position of the elastic slice 122 clamped by the two stopping blocks 133 is adjustable. Moreover, the distance between the first end of the elastic slice 122 and the clamped position of the elastic slice 122 is an available length of the elastic slice 122. The magnitude of the stiffness of the base 12 is influenced by the available length of the elastic slice 122. That is, if the clamped position of the elastic slice 122 is changed, the magnitude of the stiffness of the base 12 is changed. In case that the clamped position of the elastic slice 122 is closer to the second end of the elastic slice 122, the stiffness of the base 12 is lower. Whereas, in case that the clamped position of the elastic slice 122 is closer to the first end of the elastic slice 122, the stiffness of the base 12 is higher.

From the above descriptions, the flexible (or elastic) base 12 of the passive compliance mechanism 10 is capable of absorbing the impact. Consequently, the passive compliance mechanism 10 and the robot with the passive compliance mechanism 10 achieve the compliance. Moreover, the stiffness of the base 12 can be adjusted through the stiffness adjustment assembly 13. Consequently, the compliance of the passive compliance mechanism 10 is correspondingly adjusted. The passive compliance mechanism 10 can be applied to many kinds of the robots without the need of replacing any component or changing the design. For example, if the stiffness of the base 12 is adjusted to the maximum value, the passive compliance mechanism 10 is suitably applied to the industrial robot that requires high stiffness. If the stiffness of the base 12 is adjusted to the lower value, the passive compliance mechanism 10 is suitably applied to the service robot that requires high compliance. Alternatively, the passive compliance mechanism 10 is suitably applied to the collaboratively robot that cooperates with the user. In other words, the passive compliance mechanism 10 of the present invention is user-friendly and cost-effective.

In some embodiments, the altitude of the first end of the elastic slice 122 is equal to the altitude of the second end of the elastic slice 122. For increasing the adjustable stiffness range of the base 12 according to the clamped position of the elastic slice 122, the altitude of the elastic slice 122 is gradually decreased from the first end to the second end of the elastic slice 122.

Please refer to FIG. 1 again. The passive compliance mechanism 10 further comprises a cable rope 16 and a motor 15. The cable rope 16 is connected between the motor 15 and the sliding block 132. When the cable rope 16 is driven by the motor 15, the sliding block 132 is towed by the cable rope 16. Consequently, the sliding block 132 is moved along the linear guide 131. It is noted that the way of driving the movement of the sliding block 132 along the linear guide 131 is not restricted. For example, in another embodiment, the movement of the sliding block 132 is driven according to electromagnetic induction.

The fixing member 11 further comprises a raised block 111. The base 12 further comprises an opening 123 corresponding to the raised block 111. After the raised block 111 is penetrated through the opening 123, the base 12 is sheathed around the raised block 111. Consequently, the base 12 is installed on the fixing member 11. The passive compliance mechanism 10 further comprises a hollow pipe 19. The hollow pipe 19 runs through the center of the fixing member 11 and the center of the raised block 111. A portion of the cable rope 16 or any other wire of the passive compliance mechanism 10 can be wired through the hollow pipe 19. Consequently, the operation of the passive compliance mechanism 10 is not adversely affected by the cable rope 16 or the wire.

Moreover, the stiffness adjustment assembly 13 further comprises two position-limiting structures 134. The two position-limiting structures 134 are separately disposed on the fixing member 11. One of the two position-limiting structures 134 is located near the center of the fixing member 11. The other of the two position-limiting structures 134 is located near the outer periphery of the fixing member 11. The range between the two position-limiting structures 134 is substantially a movable range of the sliding block 132. The length of the movable range is slightly larger than or equal to the displacement of the two stopping blocks 133 from the two notches 121 to the second end of the elastic slice 122. The sliding block 132 further comprises a protrusion structure 135. The protrusion structure 135 is protruded from a lateral surface of the sliding block 132. Moreover, the protrusion structure 135 is arranged between the two position-limiting structures 134. While the sliding block 132 is moved along the linear guide 131, the movable range of the protrusion structure 135 (or the sliding block 132) is limited by the two position-limiting structures 134. That is, when the two stopping blocks 133 are moved to the two notches 121 and engaged with the two notches 121, the sliding block 132 cannot be continuously moved toward the center of the fixing member 11. Similarly, when the two stopping blocks 133 are moved to the position corresponding to the second end of the elastic slice 122, the sliding block 132 cannot be continuously moved toward the outer periphery of the fixing member 11.

In an embodiment, the passive compliance mechanism 10 further comprises a sensor 14. The sensor 14 is aligned with the base 12 and installed on the fixing member 11. The sensor 14 is used for measuring the displacement of the base 12 relative to the fixing member 11 in response to the elastic deformation. After the magnitude of the stiffness of the base 12 is obtained and the displacement of the base 12 is measured by the sensor 14, the torque of the passive compliance mechanism 10 is calculated. Consequently, the passive compliance mechanism 10 is capable of sensing the torque. In another embodiment, the sensor 14 is used for measuring the torque angle of the passive compliance mechanism 10.

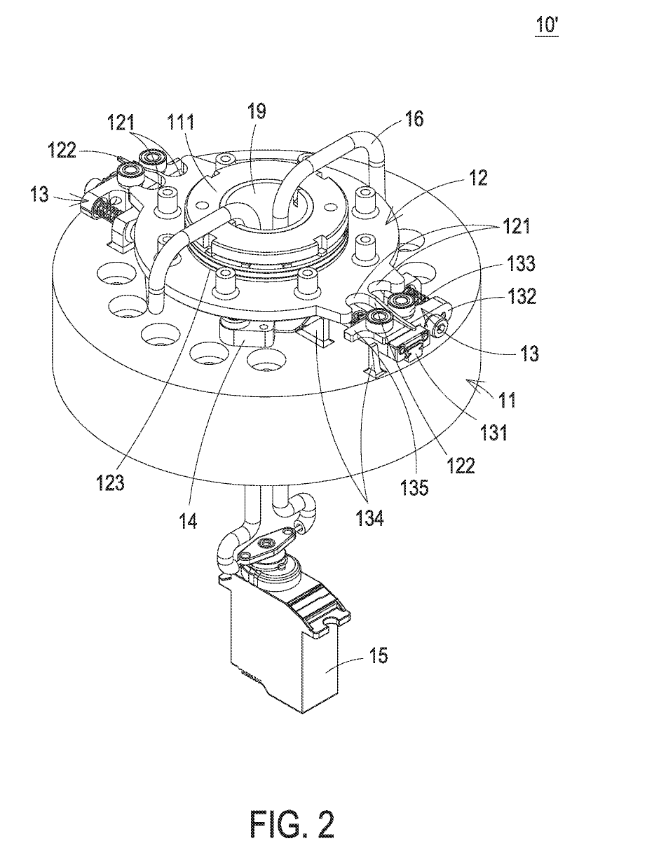

For increasing the precision of adjusting the stiffness, the passive compliance mechanism is modified. FIG. 2 is a schematic perspective view illustrating a variant example of the passive compliance mechanism of FIG. 1. In this embodiment, the passive compliance mechanism 10′ further comprises a second stiffness adjustment module. The second stiffness adjustment module comprises two notches 121, an elastic slice 122 and a stiffness adjustment assembly 13. The components, relationships and functions of the second stiffness adjustment module are similar to those of the first stiffness adjustment module, and are not redundantly described herein. In an embodiment, the first stiffness adjustment module and the second stiffness adjustment module are located at two opposite sides of the fixing member 11. In another embodiment, the first stiffness adjustment module and the second stiffness adjustment module are arranged near each other. The first stiffness adjustment module and the second stiffness adjustment module cooperate with each other to adjust the stiffness of the base. In some other embodiments, the passive compliance mechanism comprises at least three stiffness adjustment modules according to the practical requirements.

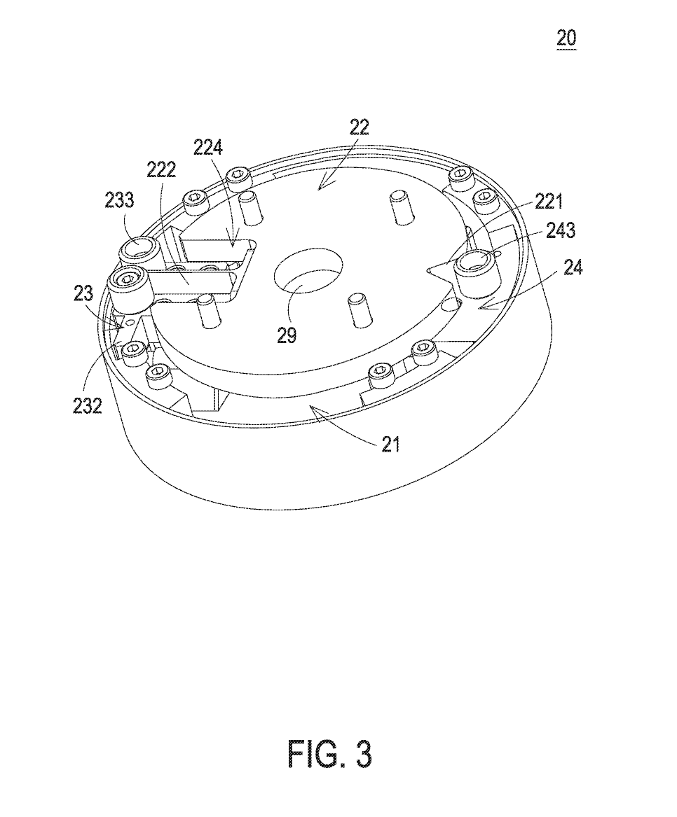

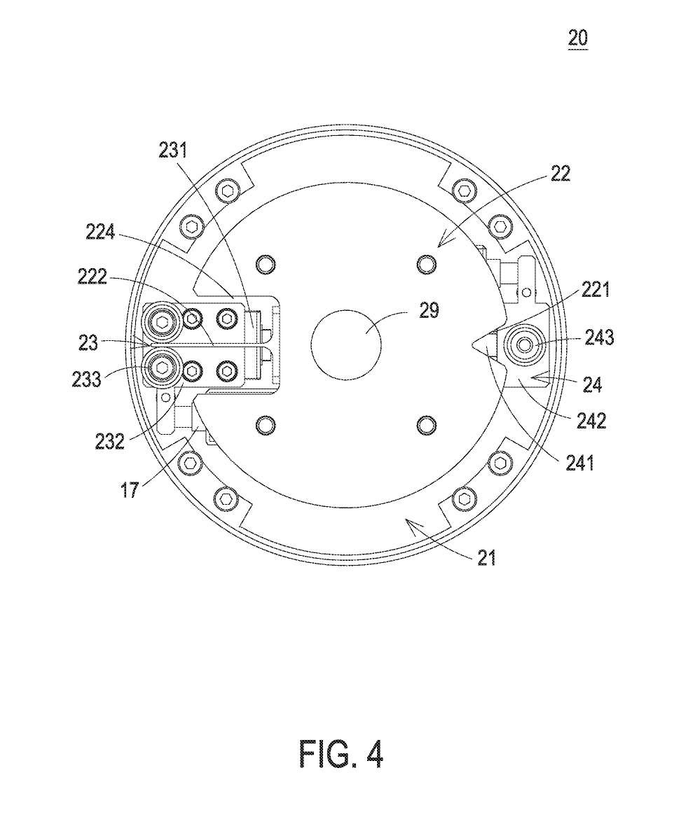

FIG. 3 is a schematic perspective view illustrating a passive compliance mechanism according to a second embodiment of the present invention. FIG. 4 is a schematic top view illustrating the passive compliance mechanism of FIG. 3. The passive compliance mechanism 20 is applied to a service robot, a collaborative robot, an industrial robot or any other appropriate robot. The passive compliance mechanism 20 is installed in a joint of an arm or a leg of the robot. In an embodiment, the passive compliance mechanism 20 comprises a fixing member 21, a base 22, a first stiffness adjustment assembly 23 and a stiffness switching module 24.

The fixing member 21 is assembled with the joint of the robot. The base 22 is installed on the fixing member 21 through a bearing (not shown). The base 22 is made of a flexible (or elastic) material. When an external force is applied to the base 22, the base 22 is subjected to an elastic deformation according to the magnitude of the stiffness of the base 22. Consequently, the base 22 is moved relative to the fixing member 21. Under this circumstance, the base 22 provides the compliant function. In this embodiment, the base 22 comprises a first notch 224, a second notch 221 and an elastic slice 222. Preferably but not exclusively, the second notch 221 is a fan-shaped notch. Moreover, the second notch 221 is concavely formed in the direction from an outer periphery of the base 22 to the center of the base 22. The elastic slice 222 is assembled with the base 22 and disposed within the first notch 224. Moreover, the elastic slice 222 is protruded externally from the base 22 in the direction toward the outer periphery of the fixing member 21. A first end of the elastic slice 222 is connected with the base 22. A second end of the elastic slice 222 is located near the outer periphery of the fixing member 21. In an embodiment, the elastic slice 222 is assembled with the base 22. Alternatively, the elastic slice 222 is integrally formed with the base 22. Moreover, the first notch 224 is divided into two receiving spaces through the elastic slice 222. Moreover, the first notch 224 and the second notch 221 are located at two opposite sides of the base 22.

The first stiffness adjustment assembly 23 is installed on the fixing member 21. In an embodiment, the first stiffness adjustment assembly 23 comprises a first linear guide 231, a first sliding block 232 and two first stopping blocks 233. The first linear guide 231 is installed on the fixing member 21. Moreover, the first linear guide 231 is aligned with the elastic slice 222. The first sliding block 232 is movably installed on the first linear guide 231. The two first stopping blocks 233 are fixedly disposed on the first sliding block 232 and synchronously moved with the first sliding block 232. Moreover, the two first stopping blocks 233 are contacted with two opposite sides of the elastic slice 222. Consequently, the elastic slice 222 is clamped by the two first stopping blocks 233. The stiffness of the base 22 is adjustable according to the position of the elastic slice 222 clamped by the two first stopping blocks 233. Moreover, the distance between the first end of the elastic slice 222 and the clamped position of the elastic slice 222 is an available length of the elastic slice 222. The magnitude of the stiffness of the base 22 is influenced by the available length of the elastic slice 222. That is, if the clamped position of the elastic slice 222 is changed, the magnitude of the stiffness of the base 22 is changed. In case that the clamped position of the elastic slice 222 is closer to the second end of the elastic slice 222, the stiffness of the base 22 is lower. Whereas, in case that the clamped position of the elastic slice 222 is closer to the first end of the elastic slice 222, the stiffness of the base 22 is higher. When the two first stopping blocks 233 are moved to the first end of the elastic slice 222, the two first stopping blocks 233 are accommodated within the receiving spaces of the first notch 224, respectively. Moreover, the first notch 224, the elastic slice 222 and the first stiffness adjustment assembly 23 are collaboratively defined as a first stiffness adjustment module. The first stiffness adjustment module can be used to adjust the magnitude of the stiffness of the base 22.

The stiffness switching module 24 is installed on the fixing member 21 and aligned with the second notch 221. In an embodiment, the stiffness switching module 24 comprises a second linear guide 241, a second sliding block 242 and a second stopping block 243. The second linear guide 241 is installed on the fixing member 21 and aligned with the second notch 221. The second sliding block 242 is movably installed on the second linear guide 241. Moreover, the second sliding block 242 can be moved to a first position or a second position. The second stopping block 243 is fixedly disposed on the second sliding block 242 and synchronously moved with the second sliding block 242.

When the second sliding block 242 is moved to the first position, the second stopping block 243 is moved to the second notch 221 and engaged with the second notch 221, and thus the base 22 has the maximum stiffness. Meanwhile, even if an external force is applied to the base 22, the base 22 is not subjected to the elastic deformation because the second stopping block 243 is engaged with the second notch 221. Consequently, the base 22 is indirectly fixed on the fixing member 21. Since the base 22 is not subjected to the elastic deformation relative to the fixing member 21, the stiffness of the base 22 is similar to the stiffness of the fixing member 21. When the second sliding block 242 is moved to the second position, the second stopping block 243 is completely disengaged from the second notch 221.

For acquiring the maximum stiffness of the base 22, the second sliding block 242 is moved to the first position. Consequently, the second stopping block 243 is moved to the second notch 221 and engaged with the second notch 221. For dynamically adjusting stiffness of the base 22, the second sliding block 242 is moved to the second position. When the clamped position of the elastic slice 222 by the first stopping blocks 233 is changed, the magnitude of the stiffness of the base 22 is adjusted.

In an embodiment, the passive compliance mechanism 20 further comprises a magnetic driving module 17. The magnetic driving module 17 is installed on the fixing member 21 and located near the first sliding block 232. The magnetic driving module 17 drives the movement of the first sliding block 232 along the first linear guide 231 according to electromagnetic induction. It is noted that the way of driving the movement of the first sliding block 232 along the first linear guide 231 is not restricted. For example, as described in the first embodiment, the use of the motor to drive to the cable rope to tow the sliding block along the linear guide is also feasible. The above driving method can be used to drive the stiffness switching module 24 in order to drive movement of the second sliding block 242 along the second linear guide 241. The passive compliance mechanism 20 further comprises a hollow pipe 29. The hollow pipe 29 runs the fixing member 21 and the base 22. A portion of the cable rope or any other wire of the passive compliance mechanism 20 can be wired through the hollow pipe 29. Consequently, the operation of the passive compliance mechanism 20 is not adversely affected by the cable rope or the wire.

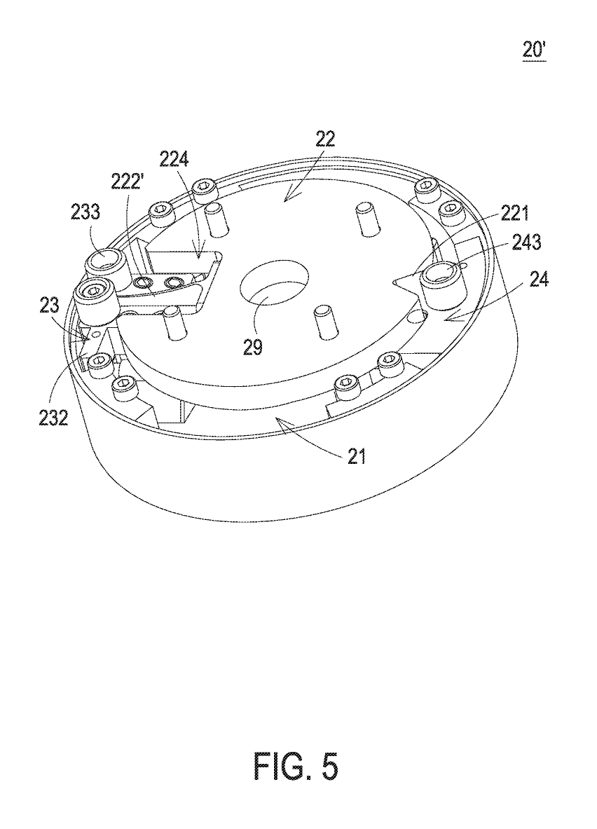

In the embodiment of FIG. 4, the altitude of the first end of the elastic slice 222 is equal to the altitude of the second end of the elastic slice 222. FIG. 5 is a schematic perspective view illustrating a variant example of the passive compliance mechanism of FIG. 3. For increasing the adjustable stiffness range of the base 22 according to the clamped position of the elastic slice 222′, the altitude of the elastic slice 222′ is gradually decreased from the first end to the second end of the elastic slice 222′. Consequently, the efficacy of adjusting the stiffness by the passive compliance mechanism 20′ is enhanced.

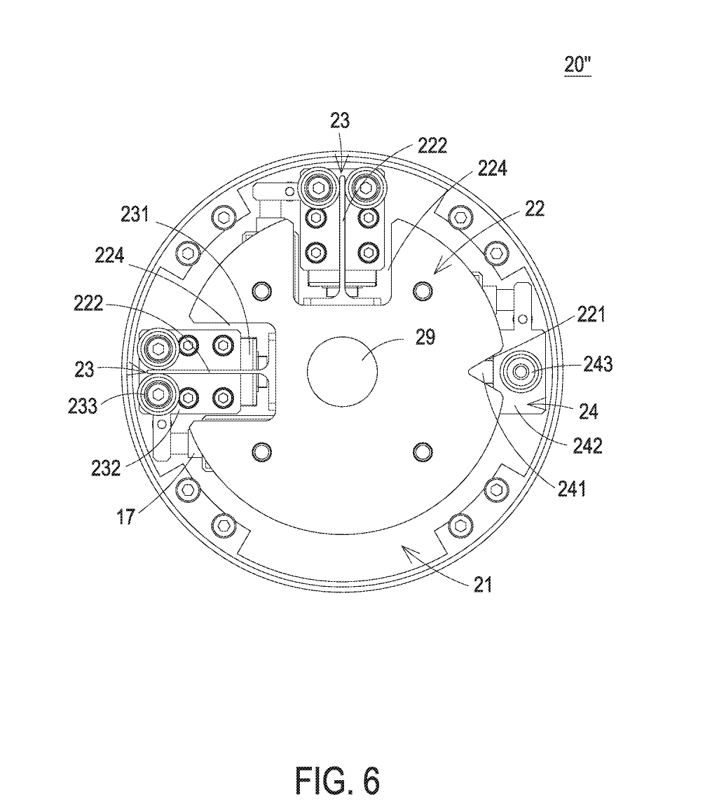

For increasing the precision of adjusting the stiffness, the passive compliance mechanism is modified. FIG. 6 is a schematic top view illustrating another variant example of the passive compliance mechanism of FIG. 3. In this embodiment, the passive compliance mechanism 20′ further comprises a second stiffness adjustment module. The second stiffness adjustment module comprises a first notch 224, an elastic slice 222 and a first stiffness adjustment assembly 23. The components, relationships and functions of the second stiffness adjustment module are similar to those of the first stiffness adjustment module, and are not redundantly described herein. In an embodiment, the first stiffness adjustment module and the second stiffness adjustment module are located at two opposite sides of the fixing member 21. In another embodiment, the first stiffness adjustment module and the second stiffness adjustment module are arranged near each other. The first stiffness adjustment module and the second stiffness adjustment module cooperate with each other to adjust the stiffness of the base. In some other embodiments, the passive compliance mechanism comprises at least three stiffness adjustment modules according to the practical requirements.

From the above descriptions, the present invention provides the passive compliance mechanism. The stiffness adjustment assembly is used to adjust the stiffness of the base. The passive compliance mechanism can be applied to many kinds of the robots without the need of replacing any component or changing the design. For example, if the stiffness of the base is adjusted to the maximum value, the passive compliance mechanism is suitably applied to the industrial robot that requires high stiffness. If the stiffness of the base is adjusted to the lower value, the passive compliance mechanism is suitably applied to the service robot that requires high compliance. Alternatively, the passive compliance mechanism is suitably applied to the collaboratively robot that cooperates with the user. In other words, the passive compliance mechanism of the present invention is user-friendly and cost-effective. For increasing the precision of adjusting the stiffness, the passive compliance mechanism comprises plural stiffness adjustment modules. A portion of the cable rope or any other wire of the passive compliance mechanism can be wired through the hollow pipe. Consequently, the operation of the passive compliance mechanism is not adversely affected by the cable rope or the wire. Moreover, the sensor is used for measuring the displacement or the distortion angle of the base relative to the fixing member in response to the elastic deformation. According to the stiffness of the base and the displacement or the distortion angle of the base, the torque of the passive compliance mechanism is calculated.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A passive compliance mechanism, comprising:
a fixing member;
a base installed on the fixing member, and comprising two notches and an elastic slice, wherein the two notches are arranged side by side, the elastic slice is arranged between the two notches and protruded externally from the base in a direction toward an outer periphery of the fixing member, a first end of the elastic slice is connected with the base, and a second end of the elastic slice is located near the outer periphery of the fixing member; and
a stiffness adjustment assembly installed on the fixing member, and comprising:
a linear guide installed on the fixing member and aligned with the elastic slice;
a sliding block movably installed on the linear guide; and
two stopping blocks fixedly disposed on the sliding block and synchronously moved with the sliding block, wherein the two stopping blocks are contacted with two opposite sides of the elastic slice to clamp the elastic slice, and a stiffness of the base is adjustable according to a clamped position of the elastic slice.

2. The passive compliance mechanism according to claim 1, wherein when the clamped position of the elastic slice clamped by the two stopping blocks is closer to the first end of the elastic slice, the stiffness of the base is higher, wherein when the clamped position of the elastic slice clamped by the two stopping blocks is closer to the second end of the elastic slice, the stiffness of the base is lower.

3. The passive compliance mechanism according to claim 2, wherein when the two stopping blocks are moved by the sliding block to the two notches and engaged with the two notches, the stiffness of the base has the maximum value.

4. The passive compliance mechanism according to claim 1, wherein the elastic slice is integrally formed with the base.

5. The passive compliance mechanism according to claim 1, wherein an altitude of the elastic slice is gradually decreased from the first end to the second end of the elastic slice.

6. The passive compliance mechanism according to claim 1, wherein the passive compliance mechanism further comprises a cable rope, and the cable rope is connected between a motor and the sliding block, wherein when the cable rope is driven by the motor, the sliding block is towed by the cable rope, so that the sliding block is moved along the linear guide.

7. The passive compliance mechanism according to claim 1, wherein the fixing member further comprises a raised block, and the base further comprises an opening, wherein the raised block is penetrated through the opening, so that the base is installed on the fixing member.

8. The passive compliance mechanism according to claim 7, further comprising a hollow pipe, wherein the hollow pipe runs through a center of the fixing member and a center of the raised block.

9. The passive compliance mechanism according to claim 1, further comprising a sensor corresponding to the base, wherein the sensor is installed on the fixing member to measure a displacement or a distortion angle of the base relative to the fixing member in response to an elastic deformation of the base.

10. The passive compliance mechanism according to claim 1, wherein the two notches, the elastic slice and the stiffness adjustment assembly are collaboratively defined as a first stiffness adjustment module, and the passive compliance mechanism further comprises a second stiffness adjustment module with the same structure as the first stiffness adjustment module, wherein the first stiffness adjustment module and the second stiffness adjustment module are located at two opposite sides of the fixing member, and the first stiffness adjustment module and the second stiffness adjustment module cooperate with each other to adjust the stiffness of the base.

11. The passive compliance mechanism according to claim 1, wherein the stiffness adjustment assembly further comprises two position-limiting structures, and the two position-limiting structures are separately disposed on the fixing member, wherein one of the two position-limiting structures is located near a center of the fixing member, and the other of the two position-limiting structures is located near the outer periphery of the fixing member, so that a movable range of the sliding block is determined by the two position-limiting structures.

12. The passive compliance mechanism according to claim 11, wherein the sliding block further comprises a protrusion structure, and the protrusion structure is protruded from a lateral surface of the sliding block and arranged between the two position-limiting structures, wherein while the sliding block is moved along the linear guide, the movable range of the sliding block is limited by the two position-limiting structures through the protrusion structure.

13. The passive compliance mechanism according to claim 12, wherein a length of the movable range is slightly larger than or equal to a displacement of the two stopping blocks from the two notches to the second end of the elastic slice.

14. A passive compliance mechanism, comprising:
a fixing member;
a base installed on the fixing member, and comprising a first notch, a second notch and an elastic slice, wherein the elastic slice is installed on the base, accommodated within the first notch, and protruded externally from the base in a direction toward an outer periphery of the fixing member, a first end of the elastic slice is connected with the base, and a second end of the elastic slice is located near the outer periphery of the fixing member;
a first stiffness adjustment assembly installed on the fixing member, and comprising:
a first linear guide installed on the fixing member and aligned with the elastic slice;
a first sliding block movably installed on the first linear guide; and
two first stopping blocks fixedly disposed on the first sliding block and synchronously moved with the first sliding block, wherein the two first stopping blocks are contacted with two opposite sides of the elastic slice to clamp the elastic slice, and a stiffness of the base is adjustable according to a clamped position of the elastic slice; and
a stiffness switching module installed on the fixing member, and comprising:
a second linear guide installed on the fixing member;
a second sliding block movably installed on the first linear guide and selectively moved to a first position or a second position; and
a second stopping block fixedly disposed on the second sliding block and synchronously moved with the second sliding block, wherein when the second sliding block is moved to the first position, the second stopping block is moved to the second notch and engaged with the second notch, so that the base has the maximum stiffness, wherein when the second sliding block is moved to the second position, the second stopping block is disengaged from the second notch.

15. The passive compliance mechanism according to claim 14, wherein when the second sliding block is moved to the second position and the clamped position of the elastic slice clamped by the two first stopping blocks is closer to the first end of the elastic slice, the stiffness of the base is higher, wherein when the second sliding block is moved to the second position and the clamped position of the elastic slice clamped by the two first stopping blocks is closer to the second end of the elastic slice, the stiffness of the base is lower.

16. The passive compliance mechanism according to claim 14, wherein the elastic slice is assembled with the base.

17. The passive compliance mechanism according to claim 14, wherein an altitude of the elastic slice is gradually decreased from the first end to the second end of the elastic slice.

18. The passive compliance mechanism according to claim 14, further comprising a magnetic driving module, wherein the magnetic driving module is installed on the fixing member and located near the first sliding block, and the magnetic driving module drives a movement of the first sliding block along the first linear guide according to electromagnetic induction.

19. The passive compliance mechanism according to claim 14, further comprising a hollow pipe, wherein the hollow pipe runs through the fixing member and the base.

20. The passive compliance mechanism according to claim 14, wherein the first notch, the elastic slice and the first stiffness adjustment assembly are collaboratively defined as a first stiffness adjustment module, and the passive compliance mechanism further comprises a second stiffness adjustment module with the same structure as the first stiffness adjustment module, wherein the first stiffness adjustment module and the second stiffness adjustment module are arranged near each other or located at two opposite sides of the fixing member, and the first stiffness adjustment module and the second stiffness adjustment module cooperate with each other to adjust the stiffness of the base.
